(19) United States
(12) Patent Application Publication
(10) Pub. No.: US 2025/0149959 A1
(43) Pub. Date: May 8, 2025

(54) Modular Electromechanical Assembly

(71) Applicant: Robert W. Bonner, Englewood, CO (US)

(72) Inventor: Robert W. Bonner, Englewood, CO (US)

(21) Appl. No.: 18/835,984

(22) PCT Filed: May 8, 2023
(86) PCT No.: PCT/US23/66744

§ 371 Date: Aug. 5, 2024

Related U.S. Application Data
(60) Provisional application No. 63/339,965, filed on May 9, 2022.

(51) Int. Cl. H02K 21/18

(52) U.S. Cl. CPC H02K 21/18; H02K 2213/12

(57) ABSTRACT

A modular electromechanical assembly is described. Embodiments of the modular electromechanical assembly can include one or more modules. The one or more modules can be configured to be implemented as a motor, a generator, and combinations thereof. Typically, the one or more modules can be removably coupled together based on a need of a user.

### CROSS-REFERENCE TO RELATED APPLICATION

This application claims the benefit of U.S. Provisional Application No. 63/339,965, filed May 9, 2022.

### BACKGROUND

Electric vehicles typically derive their operational power from onboard batteries being charged by direct current (DC) but implementing alternating current (AC) to drive the motor. In nuclear applications, steam is generated which rises to rotate a turbine to generate electricity via electromagnetic induction. At present, there is a technology vacuum regarding electricity generation in vehicles besides alternators. No applications are currently implemented to generate electricity directly from wheels or rotors in motion that are modular.

### BRIEF DESCRIPTION OF THE DRAWINGS

FIG. 1 is a block diagram of a modular electromechanical assembly according to one embodiment of the present invention.

FIG. 2 is a front view of a module according to one embodiment of the present invention.

FIG. 3 is a perspective view of a magnet attachment member according to one embodiment of the present invention.

FIG. 4 is a front view of a coil frame according to one embodiment of the present invention.

FIG. 5 is a front view of a pair of modules and a circuit diagram according to one embodiment of the present invention.

FIGS. 6A-6C include several views of different configurations of a modular electromechanical assembly according to embodiments of the present invention.

FIGS. 7A-7B include several views of a modular electromechanical assembly and components thereof configured as a generator according to one embodiment of the present invention.

### DETAILED DESCRIPTION

Embodiments of the present invention include a modular electromechanical assembly (MEA) that can include one or more modules. The one or more modules can be configured to be implemented as a motor, a generator, and combinations thereof. Typically, the one or more modules can be removably coupled together based on a need of a user. In one embodiment, the modular electromechanical assembly can include one or more modules configured to implement electromagnetic induction to generate an electrical current. In another embodiment, the modular electromechanical assembly can include one or more modules configured to implement electromagnetic induction to provide motive power. In one instance, the MEA can be implemented with a drivetrain of an automobile to recoup power and/or power the drivetrain. In another instance, the MEA can be implemented with a motorcycle to recoup power and/or power the drivetrain of the motorcycle. In yet another instance, the MEA can be configured to operatively connect to an airplane propeller. In embodiments where the MEA is configured as a generator, the male assemblies can be configured to rotate in a circular motion to interact with the female assemblies. For example, the male assemblies can be implemented as the rotor of the generator and the female assemblies can be implemented as the stator.

The MEA can be implemented to generate 3-Phase AC electricity per module. Of note, by allowing for the modules to removably couple to one another, there may be no limit on a number of modules implemented. Embodiments of the MEA configured a generator can be upgradable by adding additional modules. For instance, modules can be added on either side of the MEA along with the stacking vertically into multiple gears and multiple rows of modules per MEA. As can be appreciated, this can allow a user to multiply a total generation of electricity by a value of one per additional module.

In one instance, drive-spooling can occur when multiple modules from a single electric generator are in action, and a designated number of circuits generating separate sets of electricity have their electrical output routed to an electric motor maintaining or sustaining a rotations per minute (RPM) of the device. The remaining modules can be used to power auxiliary systems.

In some instances, the modules of the MEA can be affixed to an axle (or rim) of a wheeled vehicle. While in motion, each module can generate electricity at a rate comparable to an RPM of the axle (or rim). In other instance, when affixed to an exterior of a vessel (e.g., automobile, trailer, boat, aircraft, etc.) the module(s) of an MEA can be implemented as a wind turbine generating electricity from the wind. MEAs can also be used in static situations such as a power plant or electricity generator powered by water or fuel. Currently available generators may be modified with one or more modules to achieve a potentially higher electrical output on an as-needed basis with additional modules. Of note, the MEA can utilize renewable and non-renewable energy to achieve RPMs for electricity generation.

In one embodiment, the module(s) can include, but is not limited to, a rotor having a plurality of magnets and a stator including a plurality of coils. In another embodiment, the module(s) can include, but is not limited to, a rotor having a plurality of coils and a stator including a plurality of magnets. In a typical implementation, the module can include a pair of magnets and a pair of coils operatively configured such that one magnet acts as the north pole for a circuit and a second magnet acts as the south pole of the circuit. The pair of magnets can be located away from one another with the coils being located away from one another.

Typically, the module can include a male assembly and a female assembly. One of the assemblies can be implemented as a rotor and the other assembly can be implemented as a stator. The male assembly can include a pair of magnet members spaced apart from one another and coupled to a plate. Each of the magnet members can include a plurality of magnets where one of the magnet members has north pole outwardly facing magnets and the other magnet member has south pole outwardly facing magnets. The female assembly can include a pair of coil members each having a substantially “U” shape. In some instances, the coil members can be inverted. The coil members can include three protrusions each for receiving a coil thereon. Each coil on a first coil member can be connected to a corresponding coil on the second coil member creating a plurality of circuits. The coils can be configured such that coils on the first coil member interact with a north pole facing magnet and coils on the second coil member interact with a south pole facing magnet. When the magnet members pass through the coil members, an electrical current can be generated in each of the circuits. Of significant note, each of the circuits can implement a pair of magnets located apart from one another and a pair of coils located apart from one another.

The module can be configured to be modular. More specifically, a first module can be connected to a second module, which can be connected to a third module and so on. As can be appreciated, this can allow for a user to determine a configuration of the modules based on their needs. Further, the male assembly and the female assembly can each be implemented as the stator or the rotor.

In one example embodiment, a modular electromechanical assembly can include, but is not limited to, one or more modules, a machine, and a power bank (or source) Of note, depending on how the modules are configured, whether a power source or a power bank are implemented can be determined. For instance, if the modular electromechanical assembly is configured as a generator, the power bank can be implemented. In another instance, if the modular electromechanical assembly is configured as a motor, the power source can be implemented. In some instances, both a power bank and a power source can be implemented.

Of note, the module can be electrically connected to a power source and/or power bank. The module may also be operatively connected to a machine in some instances. For instance, a plurality of modules can be operatively connected to a wheel such that one of the male or female assemblies are configured to rotate (the rotor) and the other one of the male or female assemblies is static (the stator). In one instance, the male assembly can be implemented as a rotor and the female assembly can be implemented as the stator. In another instance, the male assembly can be implemented as a stator and the female assembly can be implemented as the rotor. The male assembly can be implemented to pass through the female assembly with magnets of the male assembly configured to pass past coils of the female assembly. The components of the male assembly and the female assembly can create three circuits where magnets moving past coils causes an electric current to be generated in the coils. Alternatively, when the coils are provided a current, they can generate a magnetic field that may interact with the magnets of the male assembly.

In one instance, the male assembly can include a pair of magnet members each including a magnet attachment member and a plurality of magnets. The magnet attachment member can have a generally cube shape with magnets located on three adjacent faces of the cube. In one instance, a bottom of the cube can be configured to secure to a plate. Depending on the magnet member, each of the magnets attached to the cube can have a north pole or a south pole facing outwards. In one instance, the plurality of magnets can generally include three permanent magnets located on different faces of the cube. A first magnet member can be configured with a north pole of the three magnets all facing outwards. A second magnet member can be configured with a south pole of the three magnets all facing outwards. In one instance, the three magnets for each magnet member can be located on a front, top, and back of the cube. A bottom of the magnet attachment members can each be coupled to a plate.

The female assembly can include a pair of coil members adapted to interface with the male assembly. The pair of coil members can each include a frame member configured to receive three sets of coils thereon. The frame members can each have a generally inverted “U” shape with coils located on protrusions of the frame. A pair of protrusions can extend down a first distance and a protrusion located in the middle can extend down a second distance. Typically, the first distance can be greater than the second distance. Each of the coils on the female assembly can be configured to interface with one of the magnets of the male assembly. For instance, the coils located on the bottom of the coil member can interface with the magnets on the front and back of the magnet member and the magnet on the top of the magnet member can interface with the coil in the middle of the coil member. Generally, coils on the pair of coil members can be connected to a corresponding coil on the other coil member. As can be appreciated, this can create three circuits. Of note, north pole facing magnets can be paired with a south pole facing magnet such that when the magnets pass through the female member, corresponding coils interact with a north pole and a south pole.

In one embodiment of the MEA, a pair of modules can be implemented together and oriented to mirror one another with a common plate supporting and coupled to male assemblies. The pair of modules can include a first male assembly, a first female assembly, a second male assembly, and a second female assembly where the second assemblies are mirroring the first assemblies. Of note, plates of the male assemblies and the frames of the female assemblies can be configured to couple to another module to allow for a user to add and remove modules as needed. In one example the plates can be male on one side and female on another side to mate with another plate. In some instances, a removable fastener (not shown) can be implemented to keep the modules coupled together.

Pairs of coils on the female assembly can be electrically connected together such that one coil interacts with a north pole facing magnet and another coil interacts with a south pole facing magnet. When a male assembly passes through the female assembly, electrically connected coils can be affected by the north pole and south pole (e.g., a magnetic field) of the magnets thus producing a current in the electrically connected coils.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### An Embodiment of a Modular Electromechanical Assembly

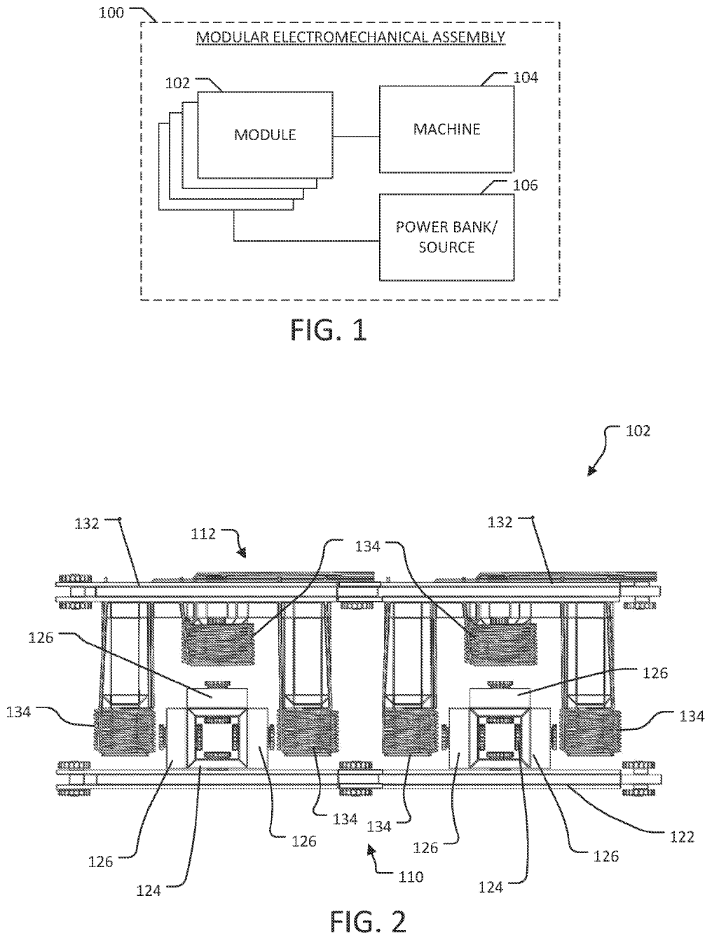

Referring to FIG. 1, a block diagram of an embodiment 100 of a modular electromechanical assembly (MES) is illustrated. The MES 100 can be implemented as a generator, motor, and combinations thereof.

As shown, the MES 100 can include, but is not limited to, one or more modules 102, a machine 104, and a power module 106 (e.g., power bank or power source). Of note, depending on how the modules 102 are configured can determine whether a power source or a power bank are implemented as the power module 106. For instance, if the modular electromechanical assembly 100 is configured as a generator, a power bank can be implemented as the power module 106. In another instance, if the modular electromechanical assembly 100 is configured as a motor, the power source can be implemented as the power module 106. In some instances, both a power bank and a power source can be implemented.

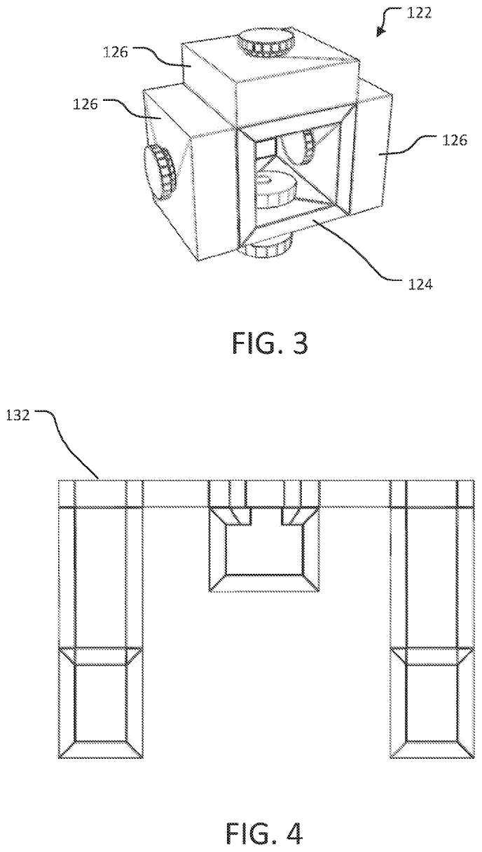

Referring to FIG. 2, a detailed diagram of one embodiment of the module 102 is illustrated. As shown, the module 102 can include, but is not limited to, a male assembly 110 and a female assembly 112. In one instance, the male assembly 110 can be implemented as a rotor and the female assembly 112 can be implemented as the stator. In another instance, the male assembly 110 can be implemented as a stator and the female assembly 112 can be implemented as the rotor.

The male assembly 110 can include a pair of magnet members 120 and a plate 122. The plate 122 can be implemented to support the magnet members 120 and for coupling to additional male assemblies. The magnet member 120 can include, but is not limited to, a magnet attachment member 124 and a plurality of magnets 126. In one instance, the magnet attachment member 124 can have a substantially cube shape. In one example, 3 permanent magnets can be implemented as the plurality of magnets 126. As shown, the plurality of magnets 126 can be located on different faces of the magnet attachment member 124. A first magnet member can be configured with a north pole of the 3 magnets all facing outwards. A second magnet member can be configured with a south pole of the 3 magnets all facing outwards. In one instance, the 3 magnets for each magnet attachment member 124 can be located on adjacent sides the cube (e.g., front, top, back or left side, right side, top). A bottom of the magnet attachment members 124 can be coupled to the plate 122.

The female assembly 112 can include a pair of coil members 130. The pair of coil members 130 can include, but are not limited to, a pair of coil frames 132 and a plurality of coils 134. The coil frames 132 can each be configured to receive some of the plurality of coils 134 thereon. Typically, the coil frames 132 can each be configured to include three coils. The pair of coil frames 132 can each have a generally inverted “U” shape. For instance, the pair of coil frames 132 can each include three protrusions each configured to receive a coil thereon a distal end. A protrusion included proximate a middle of the “U” shape can be shorter than the protrusions located on either end of the frames 132. As shown, coils 134 can be located on the distal ends of the side protrusions and one coil located on a distal end of the middle protrusion. As will be shown later, the coil on the middle protrusion can be oriented vertically.

Of note, each of the three coils 134 on each coil frame 132 can be configured to interface with one of the magnets 126 of the male assembly 110. As shown, coils 136 located on the side protrusions of the coil frame 132 can interface with the magnets 126 on the front and back (or opposing sides) of the magnet member 120. The magnet 126 on the top of the magnet attachment member 124 can interface with the coil 134 in the middle of the coil frame 132. As will be described and shown hereinafter, the plurality of coils on a first coil frame can be electrically connected to a corresponding coil on a second coil frame. As can be appreciated, the coils 134 can be electrically connected to create three circuits. Of note, an outward facing north pole magnet on a first magnet member can be paired with an outward facing south pole magnet on a second magnet member such that when the magnets pass through the female assembly 112, corresponding coils can interact with a north pole oriented magnet and a south pole oriented magnet. Depending on a configuration of the modular electromechanical assembly 100, the module 102 can be adapted to generate energy or convert electrical input into motion.

In general, a portion of the male assembly 110 can be configured to pass through a portion of the female assembly 112 with magnets 126 of the male assembly 110 configured to pass proximate electrically connected coils 134 of the female assembly 112. The components of the male assembly 110 and the female assembly 112 can be configured to create three circuits where magnets moving past coils causes an electric current to be generated in the coils. Alternatively, when the coils are provided a current, they can generate a magnetic field that may interact with the magnets of the male assembly creating a force moving the magnets.

Of note, the plate 122 of the male assembly 110 and the frame 132 of the female assembly 112 can be implemented to couple to another module 102 to allow for a user to add and remove modules as needed. In one example, the plate 122 and the frame 132 can be male on one side and female on another side to mate with another plate/frame. A removable fastener (not shown) can be implemented to keep the modules 102 coupled together.

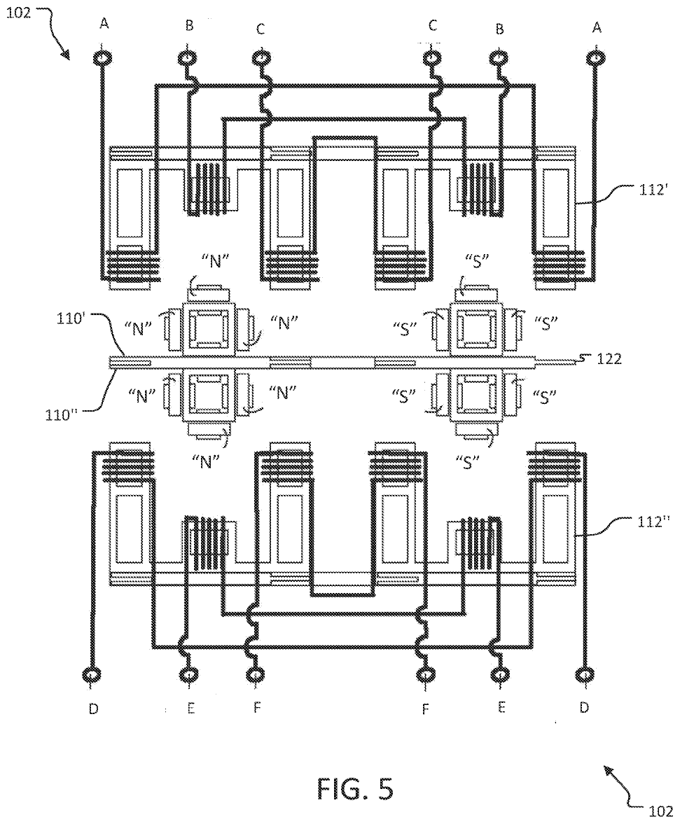

Referring to FIG. 3, a perspective view of one example embodiment of a magnet member 122 is illustrated. As shown, the magnet attachment member 124 can have a generally cube shape. In one instance, permanent magnets can be located on three adjacent faces of the cube. As previously mentioned, a bottom of the cube can be configured to secure to the plate 122. Of note, fasteners are shown securing the magnets 126 to the magnet attachment member 124. It is to be appreciated, that a variety of means for coupling the magnets 126 to the magnet attachment member 124 are contemplated and not outside a scope of the present invention.

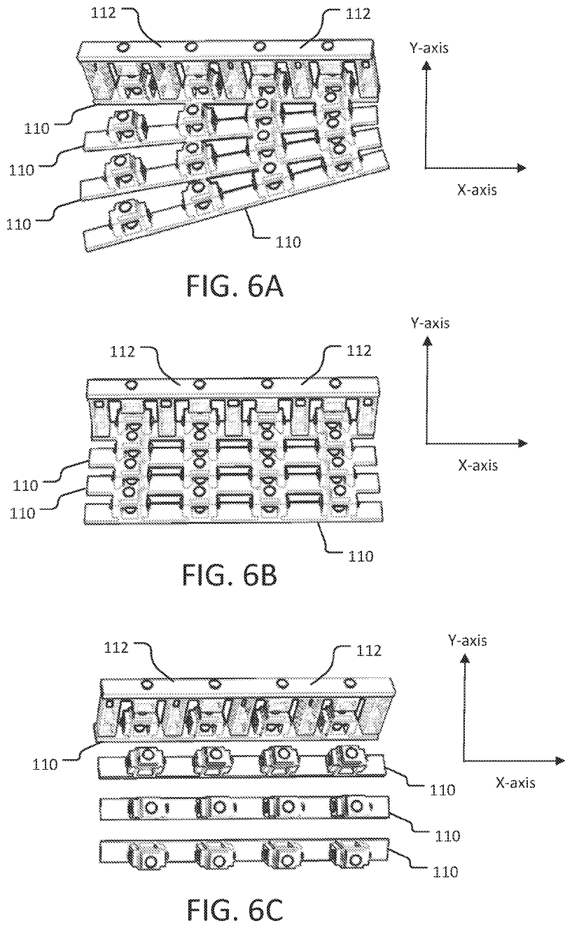

Referring to FIG. 4, a front view of a coil frame 132 without coils is illustrated. As previously mentioned, the coil frames 132 can have a substantially inverted “U” shape allowing for a portion of a magnet member 120 to pass therethrough. In the middle of the coil frame 132, a shortened protrusion can extend down to allow for a coil to be wrapped therearound. As previously mentioned, the middle coil can be configured to interact with a magnet on top of the magnet member 120.

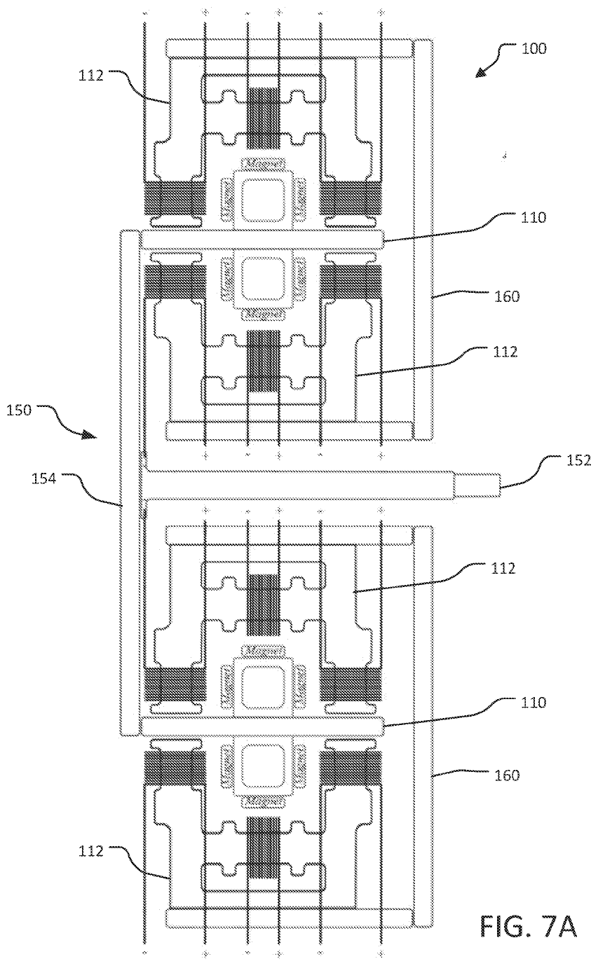

Referring to FIG. 5, a front view of components of a pair of modules 120 is illustrated. The pair of modules 120 can include a first male assembly 110′, a first female assembly 112′, a second male assembly 110″, and a second female assembly 112″ where the second assemblies are mirroring the first assemblies. Of note, a basic circuit diagram showing how the coils 134 are connected is illustrated. The first male assembly 110′ and the second male assembly 110″ can be coupled to opposite sides of the plate 122. The plate 122 can be configured to removably attach to another plate including one or more male assemblies 110.

The electrical connections shown between various coils 134 of the female assemblies 112′/112″ are for illustrative purposes and not meant to be limiting. It is to be appreciated that other electrical connections are contemplated and not outside a scope of the present invention. As shown, a circuit “A” of the first female assembly 112′ can pair coils 134 on an outside of the module 102 together. One of the magnets can be a north pole facing magnet and the other magnet can be a south pole facing magnet. When the first male assembly 110′ passes through the first female assembly 112′, the coils of the circuit “A” can be affected by the north pole and south pole (e.g., a magnetic field) of the magnets, thus producing a current in the coils. The coils of circuits “A”, “B”, “C”, “D”, “E”, and “F” can be configured to interact with a north pole facing magnet and a south pole facing magnet where the north pole facing magnet and the south pole facing magnet are two different magnets.

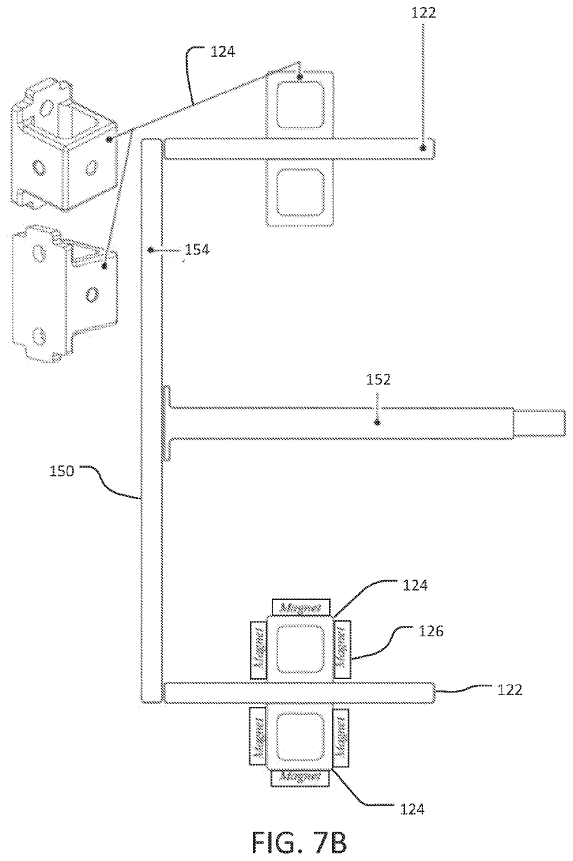

Referring to FIGS. 6A-6C, a pair of female assemblies 112 are shown with a pair of male assemblies 110 oriented in different configurations. As shown in FIG. 6A, the male assemblies 110 can be configured to rotate about a Y-axis. As shown in FIG. 6B, the male assemblies 110 can be configured to move forward and backwards on a flat surface. As shown in FIG. 6C, the male assemblies 110 can be configured to rotate about an X-axis.

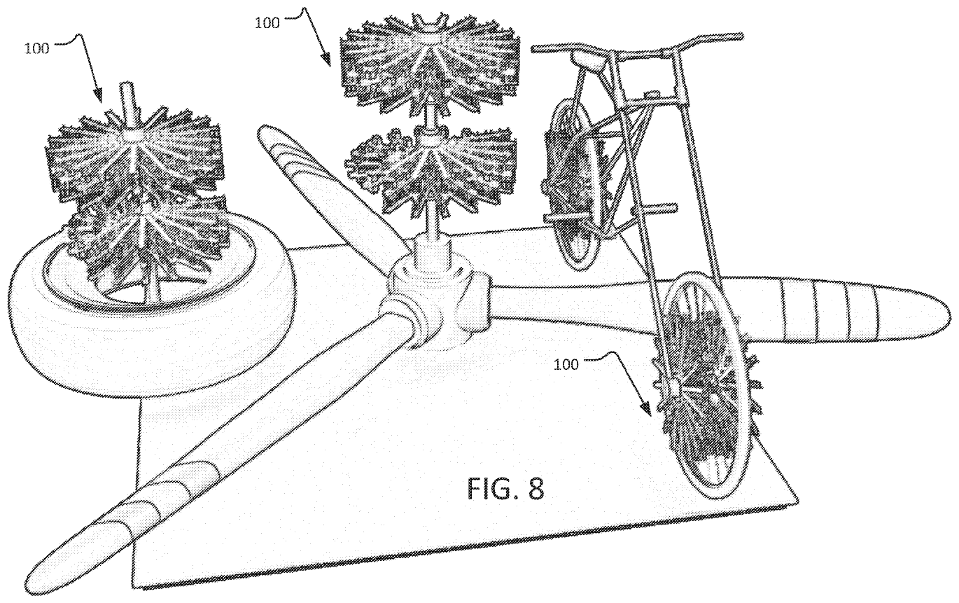

Referring to FIG. 7A-7B, an example embodiment of the modular electromechanical assembly 100 configured as a generator and components thereof are illustrated. FIG. 7A includes a side view of the generator. Of note, the male assemblies 110 of the generator can be configured to rotate in a circular motion to interact with the female assemblies 112. For example, the male assemblies 110 can be implemented as the rotor of the generator and the female assemblies 112 can be implemented as the stator.

As shown in FIG. 7B, the male assembly 110 can be integrated with an axle assembly 150. The axle assembly 150 can include, but is not limited to, an axle 152 and a frame 154. In some instances, the plates 122 of the male assemblies 120 can be integrated with the frame 154. The axle 152 can be coupled to the frame 154 such that when the axle rotates, the frame 154 can rotate. As can be appreciated, this can rotate the male assemblies 110. The axle assembly 150 can be configured such that when the axle assembly 150 may be rotating, the male assemblies 110 can be rotated in a circular motion. In such an embodiment, the male assemblies 100 can be implemented as a rotor in the generator. In one example, the axle assembly 150 may be operatively connected to a wheel of a vehicle. As can be appreciated, an engine of the vehicle may power the rotation of the wheel which may then be used to rotate the axle assembly 150.

Referring back to FIG. 7A, the female assembly 112 can be secured to a stator frame 160. The stator frame 160 can be implemented to position the female assemblies 112 to receive the male assemblies 110 therethrough as the axle assembly 150 may be rotated

Referring to FIG. 8, example embodiments of the modular electromechanical assembly 100 implemented with different types of machines is illustrated. In one instance, the MEA 100 can be implemented with a drivetrain of an automobile to recoup power and/or power the drivetrain. In another instance, the MEA 100 can be implemented with a motorcycle to recoup power and/or power the drivetrain of the motorcycle. In yet another instance, the MEA 100 can be configured to operatively connect to an airplane propeller.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A module for a modular electromechanical assembly, the module comprising:
a male assembly including:
a first magnet member having a plurality of magnets each with a “N” pole facing outwards;
a second magnet member having a plurality of magnets each with a “S” pole facing outwards; and
a plate coupled to and supporting the first magnet member and the second magnet member;
a female assembly including:
a first frame having a generally inverted “U” shape with a plurality of coils located on different locations of the first frame; and
a second frame having a generally inverted “U” shape with a plurality of coils located on different locations of the second frame;
wherein (i) the plurality of magnets of the first magnet member are adapted to interface with the plurality of coils of the first frame, and (ii) the plurality of magnets of the second magnet member are adapted to interface with the plurality of coils of the second frame.

2. The module of claim 1, wherein a first magnet on the first magnet member is adapted to interface with a first coil on the first frame electrically connected to a first coil on the second frame adapted to interface with a first magnet on the second magnet member.

3. The module of claim 1, wherein the first magnet member is defined by a cube base member with a first magnet coupled to a first side, a second magnet coupled to a top, and a third magnet coupled to a third side opposite the first side.

4. The module of claim 1, wherein the second magnet member is defined by a cube with a first magnet coupled to a first side, a second magnet coupled to a top, and a third magnet coupled to a third side opposite the first side.

5. The module of claim 1, wherein the coils of the first frame are located on bottom prongs of the generally “U” shaped frame and one coil located in the middle.

6. The module of claim 1, wherein the plate is adapted to couple to a second plate having a third magnetic member and a fourth magnetic member coupled thereto.

7. The module of claim 1, wherein the module is adapted to couple to a second module.

8. The module of claim 1, wherein the male assembly is implemented as a stator and the female assembly is implemented as a rotor.

9. The module of claim 1, wherein the male assembly is implemented as a rotor and the female assembly is implemented as a stator.
